(19) United States
(12) Patent Application Publication
(10) Pub. No.: US 2026/0099776 A1
(43) Pub. Date: Apr. 9, 2026

(54) METHOD AND APPARATUS FOR A DYNAMIC ACCOUNT SYNCHRONIZATION HUB (DASH) OF A CENTRALIZED TRAVEL PROGRAM MANAGEMENT SYSTEM

(71) Applicant: nuTravel Technology Solutions, Inc., Purchase, NY (US)

(72) Inventors: Michael Harbin, Chicago, IL (US); Rich Hunt, Ossining, NY (US)

(73) Assignee: nuTravel Technology Solutions, Inc., Purchase, NY (US)

(21) Appl. No.: 19/349,356

(22) Filed: Oct. 3, 2025

Related U.S. Application Data
(63) Continuation-in-part of application No. 17/478,082, filed on Sep. 17, 2021.
(60) Provisional application No. 63/080,912, filed on Sep. 21, 2020.
(60) Provisional application No. 63/755,320, filed on Feb. 7, 2025.

(51) Int. Cl. G06Q 10/02; H04L 9/40

(52) U.S. Cl. CPC G06Q 10/025; H04L 63/102

(57) ABSTRACT

A dynamic account synchronization hub (DASH) of a centralized travel program management system is disclosed. The dynamic account synchronization hub (DASH) of the centralized travel program management system comprises at least one processor communicatively coupled with a memory. The at least one processor is configured to receive a request from at least one traveler for an access to a travel program management platform; determine whether the at least one traveler is authorized to access the travel program management platform; determine a list of one or more service providers for the authenticated at least one traveler; receive, from the at least one traveler, a selection of service providers; link, a service provider database with an enterprise resource planning database; execute de-enrollment of the at least one traveler from the travel program management platform upon determining that the at least one traveler is not authorized to access the travel program management platform.

### CROSS REFERENCE TO RELATED APPLICATIONS

This non-provisional patent application claims the benefit under 35 U.S.C. § 199(e) of U.S. Provisional Patent Application Ser. No. 63/755,320, filed Feb. 7, 2025, and also claims the benefit under 35 U.S.C. § 120 as a continuation-in-part patent application of U.S. patent application Ser. No. 17/478,082, filed Sep. 17, 2021, which claims the benefit under 35 U.S.C. § 199(e) of U.S. Provisional Patent Application Ser. No. 63/080,912, filed Sep. 21, 2020 (and the Appendixes/Attachments filed therewith), the disclosures of each of which are all incorporated herein by reference.

### TECHNOLOGICAL FIELD OF THE INVENTION

The present invention is directed to a method and apparatus for a dynamic account synchronization hub (DASH) of a centralized travel program management system, and, more particularly, to a method and apparatus to allow for large corporate enterprises to centrally and seamlessly manage direct travel programs in one place and to enable their employees to plan and book travel directly with ease.

### BACKGROUND OF THE INVENTION

Large corporate enterprises often engage in direct relationships with multiple travel programs of service providers (e.g., an airline provider, a hotel provider, a parking service, a dining provider, a rail service, a rental car service, etc.) to optimize travel costs and benefits for their employees. However, managing the multiple travel programs individually across various travel service provider platforms presents significant challenges, particularly in the areas of one or more travelers on-boarding or off-boarding, and with consistent travel policy enforcement. Traditional systems require users to manually invite and enroll the one or more travelers into each travel program, creating inefficiencies, administrative burden, and risk of outdated traveler data. Furthermore, the travelers often face fragmented booking experiences, needing to register separately with each travel program. Such limitations create adoption hurdles and hinder visibility and control for corporate travel users.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### SUMMARY OF THE INVENTION

The following presents a simplified summary to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, an apparatus for a dynamic account synchronization hub (DASH) of a centralized travel program management system is disclosed. The dynamic account synchronization hub (DASH) of the centralized travel program management system comprises a memory having one or more computer readable instructions. The system further comprises at least one processor communicatively coupled with the memory. The at least one processor executing the one or more computer readable instructions stored in the memory is configured to receive a request from at least one traveler of one or more travelers for an access to a travel program management platform. The at least one processor is further configured to determine whether the at least one traveler is authorized to access the travel program management platform based on traveler's registration information stored in an enterprise resource planning database, changes in an employment status of the at least one traveler within the enterprise resource planning database, and real-time verification of program eligibility rules stored in a service provider database. The at least one processor is further configured to process a set of context-aware rules encoded in a non-transitory rules engine to determine a list of one or more service providers for the authenticated at least one traveler based at least on a combination of the traveler's registration information, prior travel history of the at least one traveler, or the at least one traveler's company polices, upon determining that the at least one traveler is authorized to access the travel program management platform. The at least one processor is further configured to receive, from the at least one traveler, a selection of service providers from the determined list of the one or more service providers. Further, the at least one processor is configured to link, using an application programming interface (API) module, the service provider database associated with the selected service providers by the at least one traveler with the enterprise resource planning database, for allowing the at least one traveler an access to the selected service providers via the travel program management platform. The at least one processor is configured to execute de-enrollment of the at least one traveler from the travel program management platform upon determining that the at least one traveler is not authorized to access the travel program management platform.

In some embodiments, the at least one processor executing the one or more computer readable instructions stored in the memory is configured to receive the traveler's registration information associated with the at least one traveler of the one or more travelers from at least one user for enrollment with the travel program management platform. The at least one user corresponds to a travel manager or an administrator.

In some embodiments, the at least one processor executing the one or more computer readable instructions stored in the memory is configured to store the received the traveler's registration information associated with the at least one traveler of the one or more travelers within the enterprise resource planning database.

In some embodiments, the one or more traveler's registration information comprises at least a user name, an email ID, an employee ID, a department code, an expense code, a discount code, an employment status, and a project code.

In some embodiments, the prior travel history corresponds to a log or record of each of the one or more traveler's past interactions with the one or more service providers, information related to what flights, hotels, or loyalty programs used before, and travel frequency.

In some embodiments, the at least one processor is configured to link, using the API module, the service provider database associated with the selected service providers by the at least one traveler with the enterprise resource planning database, by executing data normalization, conflict resolution across heterogeneous profile fields, and asynchronous credential synchronization using a hashing-based token map.

In some embodiments, the at least one processor executing the one or more computer readable instructions stored in the memory is further configured to generate data visualizations of the at least one traveler corresponding to the selected service providers. The data visualizations comprise at least total spend, user activity, and discount utilization.

In some embodiments, the at least one processor executing the one or more computer readable instructions stored in the memory is further configured to generate real-time analytics and reporting on the travel program management platform based on the data visualizations.

In some embodiments, the at least one processor is further configured to authenticate, using a single sign-on mechanism, enrollment of the at least one traveler with the travel program management platform by validating the traveler's registration information in the enterprise resource planning database. The single sign-on mechanism performs multi-factor cryptographic token validation using the enterprise resource planning database and dynamic session allocation for a secure access to a unified travel booking interface of the travel program management platform.

In some embodiments, the unified travel booking interface is configured to provide a unified access to each of the one or more service providers. The one or more service providers comprises at least one of an airline provider, a hotel provider, a parking service, a dining provider, a rail services and a rental car service.

In another example embodiment, a method for a dynamic account synchronization hub (DASH) of a centralized travel program management system is disclosed. The method comprises receiving, via at least one processor communicatively coupled with a memory having one or more computer readable instructions, a request from at least one traveler of one or more travelers for an access to a travel program management platform. The method further comprises determining, via the at least one processor, whether the at least one traveler is authorized to access the travel program management platform based on traveler's registration information stored in an enterprise resource planning database, changes in an employment status of the at least one traveler within the enterprise resource planning database, and real-time verification of program eligibility rules stored in a service provider database. Further, the method comprises processing, via the at least one processor, a set of context-aware rules encoded in a non-transitory rules engine to determine a list of one or more service providers for the authenticated at least one traveler based at least on a combination of the traveler's registration information, prior travel history of the at least one traveler, or the at least one traveler's company polices, upon determining that the at least one traveler is authorized to access the travel program management platform. Further, the method comprises receiving, via the at least one processor, from the at least one traveler, a selection of service providers from the determined list of the one or more service providers. Further, the method comprises linking, via the at least one processor, using an application programming interface (API) module, the service provider database associated with the selected service providers by the at least one traveler with the enterprise resource planning database, for allowing the at least one traveler an access to the selected service providers via the travel program management platform. Thereafter, the method comprises executing, via the at least one processor, de-enrollment of the at least one traveler from the travel program management platform upon determining that the at least one traveler is not authorized to access the travel program management platform.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a centralized travel program management system in accordance with an example embodiment of the present disclosure;

FIG. 2 illustrates a block diagram of a server and a travel program management platform in accordance with an example embodiment of the present disclosure;

FIG. 3 illustrates a system architecture for the centralized travel program management system showing data communication in accordance with an example embodiment of the present disclosure;

FIG. 4 illustrates a schematic diagram of a centralized travel program management hub showing integration of one or more service providers in accordance with an example embodiment of the present disclosure;

FIG. 5 illustrates another block diagram of the centralized travel program management system in accordance with an example embodiment of the present disclosure;

FIGS. 6A-6B illustrate user interface of the centralized travel program management platform in accordance with an example embodiment of the present disclosure;

FIG. 7 illustrates a user interface of the centralized travel program management platform in accordance with an example embodiment of the present disclosure;

FIG. 8 illustrates a traveler analytics dashboard of the centralized travel program management platform in accordance with an example embodiment of the present disclosure; and

FIG. 9 illustrates a flowchart showing a method for accessing the one or more service providers in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a dynamic account synchronization hub (DASH) of a centralized travel program management system. Embodiments may be configured to receive a request from at least one traveler of one or more travelers for an access to a travel program management platform. Embodiments may be further configured to determine whether the at least one traveler is authorized to access the travel program management platform. Embodiments may be configured to process a set of context-aware rules encoded in a non-transitory rules engine to determine a list of one or more service providers for the authenticated at least one traveler. Embodiments may be further configured to receive, from the at least one traveler, a selection of service providers from the determined list of the one or more service providers. Embodiments may be further configured to link, using an application programming interface (API) module, the service provider database associated with the selected service providers by the at least one traveler with the enterprise resource planning database, for allowing the at least one traveler an access to the selected service providers via the travel program management platform. Embodiments may be further configured to execute de-enrollment of the at least one traveler from the travel program management platform upon determining that the at least one traveler is not authorized to access the travel program management platform.

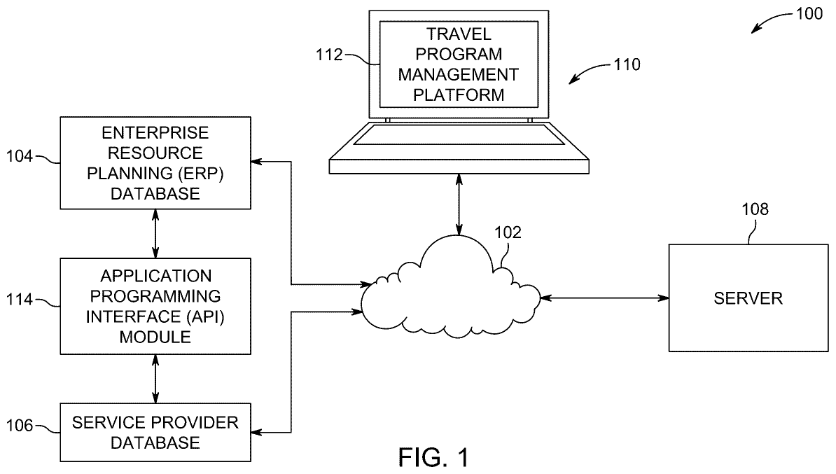

FIG. 1 illustrates a network diagram of a centralized travel program management system 100 in accordance with an example embodiment of the present disclosure. The centralized travel program management system 100 may comprise a server 108 communicatively coupled to an enterprise resource planning (ERP) database 104 and a service provider database 106 via a network 102, a travel program management platform 112 operationally installed within a user device 110, and an application programming interface (API) module 114.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the centralized travel program management system 100 may connect to the network 102 in accordance with various wired and wireless communication protocols such as Transmission Control Protocol and Internet Protocol (TCP/IP), One or more travelers Datagram Protocol (UDP), and 2G, 3G, 4G or 5G communication protocols.

In some embodiments, the centralized travel program management system 100 may be referred to as a system 100. Further, the system 100 may comprise the ERP database 104. The ERP database 104 may correspond to a database that is associated with an enterprise of one or more travelers. The ERP database 104 may correspond to a centralized data repository maintained by the enterprise for storing and managing information related to the one or more travelers. The at least one traveler may correspond to an employee of the enterprise. The ERP database 104 may store one or more traveler's registration information of the at least one traveler. The one or more traveler's registration information of the at least one traveler may comprise at least a user name, an email ID, an employee ID, a department code, an expense code, a discount code, and a project code, and an employment status of the at least one traveler.

The user name may comprise a first name and a last name of each of the at least one traveler. The email ID may be associated with each of the one or more travelers. The employee ID may be uniquely assigned by the enterprise to the at least one traveler. The department code may correspond to a section of the enterprise to which each of the one or more travelers may belong to within the enterprise. The discount code may be applicable on travel bookings for each of the one or more travelers. Further, the project code may correspond to a code corresponding to a specific enterprise project under which the travel may be booked or billed. In some embodiments, the ERP database 104 may correspond to an authoritative source of identity of the one or more travelers and organizational data. The ERP database 104 may be integrated with an identity provider (IDP). The IDP may be configured to authenticate the one or more travelers. Further, the IDP may be configured to manage digital identities of the one or more travelers. Further, the IDP may be configured to issue secure authentication token for the authenticated one or more travelers In some embodiments, the ERP database 104 may store data associated with the employment status of each of the one or more travelers. The employment status may correspond to onboarding and off-boarding of the one or more travelers within the enterprise.

In some embodiments, the service provider database 106 may correspond to a directory associated with one or more service providers. The one or more service providers may comprise at least one of an airline provider, a hotel provider, a parking service, a dining provider, rail services, and a rental car service. The service provider database 106 may store account status of the one or more travelers, loyalty program data, travel preferences, transaction history, and booking history. In some embodiments, the service provider database 106 may be configured to store program eligibility rules. The program eligibility rules may correspond to a set of predefined criteria and conditions that may determine whether each of the one or more travelers is allowed to enroll in, access, or continue using the service providers from the one or more service providers under a corporate arrangement. In an example embodiment, the program eligibility rules may comprise an employment status rule, a region-specific access, a departmental permission, a budget limit, or an approval limit.

In some embodiments, the server 108 may be a computer or a software module that is configured to provide centralized resources, data, or services to the user device 110 operated by at least one user. The server 108 may be configured to handle and manage one or more computational tasks and data processing within the system 100. In some embodiments, the server 108 may include storage systems, such as hard drives or storage arrays, to store and manage large volumes of data and information accessible to network users. In some embodiments, the server 108 may further provide centralized control and management capabilities, allowing network users to configure, monitor, and maintain network resources, security settings, and one or more travelers access permissions from a single location.

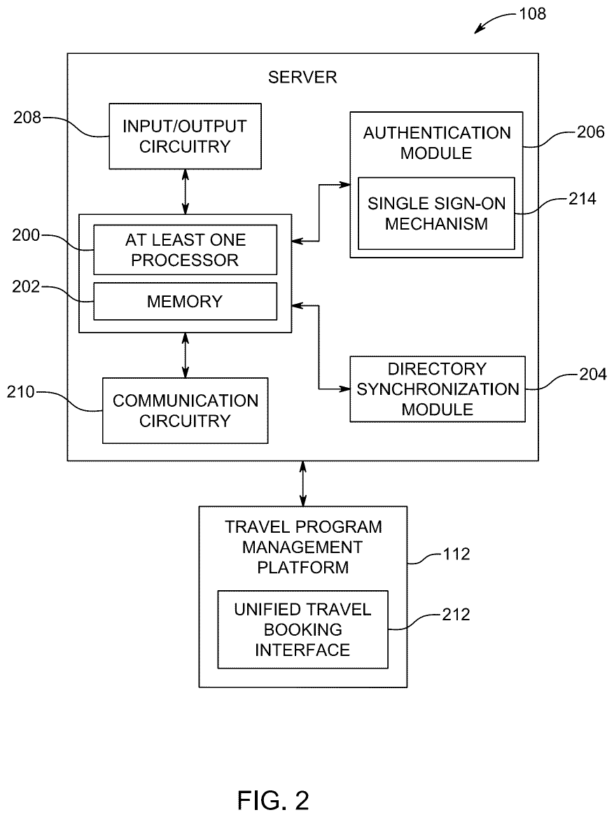

In some embodiments, the server 108 may comprise a memory, and at least one processor (described in FIG. 2). The memory may have one or more computer readable instructions. The at least one processor may be communicatively coupled to the memory. In some embodiments, the server 108 may be configured to receive a request from at least one traveler of the one or more travelers for an access to a travel program management platform 112. The server 108 may be configured to receive the request from the at least one traveler via the user device 110. The request may correspond to a login request to access the travel program management platform 112. The travel program management platform 112 may correspond to a centralized platform configured to manage, streamline, and optimize all aspects of enterprise travel for the one or more travelers. The at least one traveler may enter login credentials associated with the request. The one or more travelers may send the request to the server 108 through the user device 110. The one or more travelers may send the request to the server 108 by entering the login credentials. The login credentials may comprise at least one of the user name, a mobile number, or the user ID, and a password associated with the user name, the mobile number, or the user ID. The request may be sent over the network 102 to the server 108. The server 108 may be further configured to handle a login process based at least on the request.

In some embodiments, the server 108 may be configured to authenticate enrollment of the one or more travelers with the travel program management platform 112 by validating the one or more traveler's registration information in the ERP database 104, using a single sign-on (SSO) mechanism. The one or more traveler's registration information may comprise at least the user name, the email ID, the employee ID, the department code, the expense code, the discount code, and the project code. The server 108 may be configured to determine whether the at least one traveler of the one or more travelers is eligible to access the travel program management platform 112 or not by verifying the one or more traveler's registration information in the ERP database 104. The server 108 may be configured to authenticate the one or more travelers via the SSO mechanism integrated with the IDP associated with the ERP database 104. The IDP integrated with the SSO mechanism may comprise identity providers and directory services, such as cloud-based or on-premises solutions supporting standard federation protocols. The ERP database 104 may be associated with the enterprise. The at least one traveler may be authenticated based on the one or more traveler's registration information of the at least one traveler.

In some embodiments, the SSO mechanism may perform multi-factor cryptographic token validation using the ERP database 104 and dynamic session allocation for a secure access to a unified travel booking interface of the travel program management platform 112. The unified travel booking interface may be configured to provide a unified access to each of the one or more service providers. In some embodiment, the one or more service providers may correspond to at least one of an airline provider, a hotel provider, a parking service, a dining provider, rail services, and a rental car service.

In some embodiments, the SSO mechanism may use multi-factor cryptographic token to validate the one or more traveler's registration information. The SSO mechanism may allow the at least one traveler to log in just once to access one or more service providers, without sending the request again and again. The multi-factor cryptographic token may comprise a one-time password (OTP) sent to the user device 110, a hardware token, or a biometric check. The multi-factor cryptographic token may be digitally signed or encrypted to prevent tampering and may be validated using data from the ERP database 104. The multi-factor cryptographic token may ensure that only the at least one traveler approved by the enterprise are allowed to access the travel program management platform 112.

In some embodiments, after authenticating the at least one traveler, the server 108 may determine whether the at least one traveler is authorized to access the travel program management platform 112. The server 108 may be configured to determine whether the at least one traveler may be authorized to access the travel program management platform 112 based on the one or more traveler's registration information stored in the ERP database 104, changes in an employment status of the at least one traveler within the ERP database 104, and real-time verification of the program eligibility rules stored in the service provider database 106. The server 108 may confirm from the one or more traveler's registration information whether the at least one traveler trying to access the travel program management platform 112 is officially registered and recognized by the enterprise.

Further, the server 108 may look at changes in the employment status of the at least one traveler within the ERP database 104. In one example, if the at least one traveler has left the company, been transferred to a different role, or is no longer eligible for travel benefits, the change in the employment status of the at least one traveler may be reflected in the ERP database 104. The server 108 may use the employment status of the at least one traveler to automatically restrict access for the at least one traveler who are no longer authorized to access the travel program management platform 112. Further, the server 108 may perform real-time verification of the program eligibility rules that is stored in the service provider database 106. The program eligibility rules may be set by the enterprise or the one or more service providers. The program eligibility rules may define one or more conditions under which the at least one traveler may access certain benefits, discounts, or the loyalty programs.

In some embodiments, once the at least one traveler is authenticated, the server 108 may establish the access to the unified travel booking interface of the travel program management platform 112 through the dynamic session allocation. The dynamic session allocation may involve creating a secure, and temporary session for the at least one traveler to interact with the travel program management platform 112. Each session may be time-limited to reduce a risk of misuse of the access. The dynamic session allocation may ensure that only the authorized at least one user may access the travel program management platform 112 during a valid session timeframe.

In some embodiments, the server 108 may be configured to allow the authorized traveler to access the unified travel booking interface based on the authentication. The unified travel booking interface may be configured to provide the unified access to each of the one or more service providers. The authorization may involve verifying whether the at least one traveler is permitted to access the unified travel booking interface and determining an appropriate level of access based on one or more attributes. The one or more attributes may comprise at least one of a designation of the one or more travelers, the department of the one or more travelers, or the project code.

In some embodiments, once the at least one traveler is successfully authenticated, the server 108 may be configured to grant access to the unified travel booking interface. The access may be granted through the SSO mechanism using the IDP. The unified travel booking interface may correspond to a centralized platform that brings together the one or more service providers at one place. Rather than requiring the at least one traveler to log in separately to different platforms for each of the one or more service providers, the unified travel booking interface may allow the at least one traveler to view, select, and manage the one or more service providers through a single access point. The one or more service providers may correspond to at least one of the airline provider, the hotel provider, the parking service, the dining provider, the rail services, and the rental car service.

In some embodiments, the server 108 may be configured to process a set of context-aware rules encoded in a non-transitory rules engine to determine a list of the one or more service providers for the authenticated at least one traveler based at least on a combination of the traveler's registration information, prior travel history of the at least one traveler, or the at least one traveler's company polices, upon determining that the at least one traveler is authorized to access the travel program management platform 112. The prior travel history may correspond to a log or record of each of the one or more traveler's past interactions with the one or more service providers.

The prior travel history may comprise information related to what flights, hotels, or loyalty programs used before, and travel frequency. Further, the at least one traveler's company polices may correspond to travel management rules and restrictions defined by the enterprise. The at least one traveler's company polices may include approved airlines, hotel chains, booking class restrictions, or travel budget limits. In some embodiments, by utilizing the combination of the traveler's registration information, prior travel history of the at least one traveler, or the at least one traveler's company polices, the server 108 may dynamically determine a personalized list of the one or more service providers for each of the authenticated traveler of the one or more travelers. In some embodiments, the server 108 may be configured to display the determined list of the one or more service providers to the at least one traveler via the user device 110.

In some embodiments, the server 108 may be configured to receive a selection of service providers from the displayed list of the one or more service providers. After the determined list of the one or more service providers is displayed on the user device 110, the server 108 may be configured to receive the selection of service providers.

In some embodiments, once the server 108 receives the selection of service providers, the server 108 may be configured to enable the at least one traveler to search for and book at least one ticket from the selected service providers. The unified travel booking interface may be configured to allow the at least one traveler to perform travel-related operations. The travel-related operations may comprise at least one of entering travel details, viewing available travel options, and confirming a booking. The travel details may comprise at least one of source, destinations, dates, and preferences. The booking interface may further provide the unified access to the one or more service providers comprising at least one of the airline provider, the hotel provider, the parking service, the dining provider, the rail services, and the rental car service. Through the unified access to the one or more service providers, the at least one traveler may conveniently interact with the one or more service providers from a single travel program management platform 112.

In some embodiments, the server 108 may be configured to initiate a directory linkage between the ERP database 104 associated with the enterprise and the service provider database 106 associated with the selected service providers from the one or more service providers via the API module 114. Once the one or more travelers selects the service providers from the one or more service providers, the server 108 may be configured to initiate the directory linkage. The directory linkage may be established between the ERP database 104 and the service provider database 106. The ERP database 104 may store the one or more traveler's registration information of the at least one traveler and organizational information for the enterprise. Further, the service provider database 106 may be associated with the selected service providers from the one or more service providers.

In some embodiments, the server 108 may be configured to link, using an application programming interface module 114, the service provider database 106 associated with the selected service providers with the ERP database 104. The linking process may be performed by executing data normalization, conflict resolution across heterogeneous profile fields, and asynchronous credential synchronization using a hashing-based token map. The linking process may allow the at least one traveler to access the selected service providers via the travel program management platform 112. The directory linkage may be created using the API module 114. The API module 114 may act as a secure communication bridge that may allow the ERP database 104, and the service provider database 106 to exchange information. The API module 114 may be configured to support automated communication protocols that may enable seamless interaction between the ERP database 104 and the service provider database 106. The API module 114 may be further configured to ensure that data may be transmitted in a structured and compatible format. The API module 114 may be further configured to provide authentication and encryption layers to protect sensitive information during exchange. By initiating the directory linkage, the server 108 may enable the selected service providers from the one or more service providers to access one or more details of the at least one traveler from the one or more traveler's registration information.

In some embodiments, the server 108 may be configured to synchronize the one or more traveler's registration information of the one or more travelers from the ERP database 104 with the service provider database 106 associated with the selected service providers via a directory synchronization module (described in FIG. 2). After establishing the directory linkage between the ERP database 104 and the service provider database 106, the server 108 may be configured to synchronize the one or more traveler's registration information between the ERP database 104 and the service provider database 106. The directory synchronization module may ensure that the one or more traveler's registration information of the at least one traveler in the ERP database 104 may be automatically and accurately copied, and updated in the service provider database 106. By performing the synchronization process, the server 108 may ensure that each of the one or more service providers may have the recent one or more traveler's registration information.

In some embodiments, the server 108 may be configured to perform automatic enrollment or de-enrollment of the at least one traveler in the selected service providers from the one or more service providers based on the employment status of the at least one traveler within the ERP database 104. The employment status of the at least one traveler may correspond to whether the at least one traveler is working in the enterprise or not. The server 108 may be configured to add or remove the at least one traveler from the service provider database 106 based at least on addition and removal of the at least one traveler to or from the ERP database 104.

In some embodiments, if the ERP database 104 shows that at least one traveler is currently employed by the enterprise, then the server 108 may automatically enroll the at least one traveler into the selected service providers. The server 108 may be configured to receive the traveler's registration information associated with the at least one traveler of the one or more travelers from at least one user for enrollment with the travel program management platform 112. The server 108 may be further configured to store the received the traveler's registration information associated with the at least one traveler of the one or more travelers within the ERP database 104. Further, if the ERP database 104 indicates that the at least one traveler has left the enterprise, then the server 108 may automatically de-enroll the at least one traveler from the selected service providers. In some embodiments, the server 108 may be further configured to execute de-enrollment of the at least one traveler from the travel program management platform 112 upon determining that the at least one traveler is not authorized to access the travel program management platform 112.

In some embodiments, the server 108 may be further configured to detect the changes in the employment status of the at least one traveler in the ERP database 104 indicating the at least one traveler has left the enterprise. If the one or more traveler's registration information of the at least one traveler is removed from the ERP database 104, then the server 108 may detect the removal of the one or more traveler's registration information of the at least one traveler. The removal of the one or more traveler's registration information of the at least one traveler may indicate that the at least one traveler has left the enterprise.

In some embodiments, the server 108 may be further configured to transmit a deactivation instruction via the API module 114 to the service provider database 106 associated with each of the one or more service providers. Once the server 108 detects that the at least one traveler has left the enterprise, the server 108 may be configured to generate a deactivation instruction. The server 108 may be configured to transmit the generated deactivation instruction through the API module 114. The deactivation instruction may be sent to the service provider database 106 associated with the selected service providers in which the at least one traveler was previously enrolled in. The deactivation instruction may ensure that the at least one traveler has left the enterprise and has no longer access to the one or more service providers.

In some embodiments, the server 108 may be further configured to revoke access for the at least one traveler to the unified travel booking interface based on the deactivation instruction. The server 108 may be configured to use the deactivation instruction to revoke the access for the at least one traveler to the unified travel booking interface. The at least one traveler may no longer be able to log in, view, or interact with the system 100. The revocation may maintain data security, and may further ensure compliance with enterprise access policies, and may prevent unauthorized travel activity by the at least one traveler who are no longer affiliated with the enterprise.

In some embodiments, the one or more service providers may be displayed on the user device 110. The user device 110 comprises a graphical user interface (GUI) that provides a user-friendly platform for the at least one traveler to enter the login credentials and interact with the system 100. The GUI may be web-based, accessed through a browser, or through a dedicated software application installed on desktop computers, laptops, tablets, or smartphone. The user device 110 may be equipped by a user or other service professionals responsible for managing the one or more service providers. In some embodiments, the user device 110 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

FIG. 2 illustrates a block diagram of the server 108 and the travel program management platform 112 in accordance with an example embodiment of the present disclosure.

In some embodiments, the server 108 may further comprise at least one processor 200, a memory 202, a directory synchronization module 204, an authentication module 206, an input/output circuitry 208, and a communication circuitry 210. Further, the travel program management platform 112 may comprise the unified travel booking interface 212. Further, the authentication module 206 may further comprise a SSO mechanism 214.

In some embodiments, the at least one processor 200 may be configured for executing the one or more computer readable instructions stored in the memory 202. In some embodiments, the at least one processor 200 may be configured to receive the request from the at least one traveler of the one or more travelers for the access to the travel program management platform 112, via the user device 110. The request may correspond to the login request to access the travel program management platform 112. The travel program management platform 112 may correspond to the centralized platform configured to manage, streamline, and optimize all aspects of enterprise travel for the one or more travelers. The at least one user may enter the login credentials associated with the request entered by the at least one traveler. The login credentials may comprise at least one of the user name, the mobile number, the user ID, and the password associated with the user name, the mobile number, or the user ID. It may be noted that the request may be sent over the network 102 to the at least one processor 200.

In some embodiments, the at least one processor 200 may be configured to authenticate enrollment of the one or more travelers with the travel program management platform 112 by validating the one or more traveler's registration information in the ERP database 104, using the SSO mechanism 214. The one or more traveler's registration information may comprise at least the user name, the email ID, the employee ID, the department code, the expense code, the discount code, and the project code. The at least one processor 200 may be configured to determine whether the at least one traveler of the one or more travelers is eligible to access the travel program management platform 112 or not by verifying the one or more traveler's registration information in the ERP database 104. The at least one processor 200 may be configured to authenticate the one or more travelers via the SSO mechanism 214 integrated with the IDP associated with the ERP database 104. The IDP integrated with the SSO mechanism 214 may comprise identity providers and directory services, such as cloud-based or on-premises solutions supporting standard federation protocols. The ERP database 104 may be associated with the enterprise. If the one or more travelers are allowed, then the at least one processor 200 may successfully authenticate the one or more travelers via an authentication module 206. The at least one traveler may be authenticated based on the one or more traveler's registration information of the at least one traveler.

In some embodiments, the authentication module 206 may be configured to verify an identity of the one or more travelers attempting to access the system 100. After receiving the request from the at least one traveler, the at least one processor 200 may communicate with the authentication module 206 to determine whether the login credentials entered by the at least one traveler are valid and authorized for access. The authentication module 206 may be communicatively coupled to the SSO mechanism 214. The SSO mechanism 214 may allow the one or more travelers to sign in using the login credentials provided by the enterprise. The authentication module 206 may be further configured to generate and transmit an authentication request to the IDP.

In some embodiments, the authentication module 206 may be further configured to receive a response corresponding to the authentication request. The received response may indicate whether the login credentials are valid or not. The received response may be further transmitted to the at least one processor 200. If the received response confirms that the login credentials entered by the one or more travelers are valid, the authentication module 206 may complete the authentication process, and the at least one traveler may be granted access to the unified travel booking interface 212. Further, the received response confirms that the login credentials entered by the one or more travelers are not valid, then the access may be denied.

In some embodiments, the SSO mechanism 214 may perform multi-factor cryptographic token validation using the ERP database 104 and dynamic session allocation for a secure access to the unified travel booking interface 212 of the travel program management platform 112. The unified travel booking interface 212 may be configured to provide a unified access to each of the one or more service providers. The one or more service providers comprises at least one of the airline provider, the hotel provider, the parking service, the dining provider, the rail services and the rental car service.

In some embodiments, the SSO mechanism 214 may use multi-factor cryptographic token to validate the one or more traveler's registration information. The SSO mechanism 214 may allow the at least one traveler to log in just once to access one or more service providers, without sending the request again and again. The multi-factor cryptographic token may comprise a one-time password (OTP) sent to the user device 110, a hardware token, or a biometric check. The multi-factor cryptographic token may be digitally signed or encrypted to prevent tampering and may be validated using data from the ERP database 104. The multi-factor cryptographic token may ensure that only the at least one traveler approved by the enterprise are allowed to access the travel program management platform 112.

In some embodiments, after authenticating the at least one traveler, the at least one processor 200 may determine whether the at least one traveler is authorized to access the travel program management platform 112. The at least one processor 200 may be configured to determine whether the at least one traveler may be authorized to access the travel program management platform 112 based on the one or more traveler's registration information stored in the ERP database 104, changes in an employment status of the at least one traveler within the ERP database 104, and real-time verification of the program eligibility rules stored in the service provider database 106. The at least one processor 200 may confirm from the one or more traveler's registration information whether the at least one traveler trying to access the travel program management platform 112 is officially registered and recognized by the enterprise. Further, the at least one processor 200 may look at changes in the employment status of the at least one traveler within the ERP database 104.

In one example, if the at least one traveler has left the company, been transferred to a different role, or is no longer eligible for travel benefits, then the change in the employment status of the at least one traveler may be reflected in the ERP database 104. The at least one processor 200 may use the employment status of the at least one traveler to automatically restrict access for the at least one traveler who are no longer authorized to access the travel program management platform 112. Further, the at least one processor 200 may perform real-time verification of the program eligibility rules that may be stored in the service provider database 106. The program eligibility rules may be set by the enterprise or the one or more service providers. The program eligibility rules may define one or more conditions under which the at least one traveler may access certain benefits, discounts, or the loyalty programs.

In some embodiments, once the at least one traveler is successfully authenticated, the at least one processor 200 may be configured to grant access to the unified travel booking interface 212. The access may be granted through the SSO mechanism 214 using the IDP. The unified travel booking interface 212 may correspond to a centralized platform that may bring together the one or more service providers in one place. Rather than requiring the at least one traveler to log in separately to different platforms for each of the one or more service providers, the unified travel booking interface may allow the at least one traveler to view, select, and manage the one or more service providers through a single access point. The one or more service providers may at least one of the airline provider, the hotel provider, the parking service, the dining provider, the rail services and the rental car service.

In some embodiments, the at least one processor 200 may be configured to process the set of context-aware rules encoded in the non-transitory rules engine. The at least one processor 200 may be configured to determine the list of the one or more service providers for the authenticated at least one traveler. The determination may be based at least on a combination of the traveler's registration information, prior travel history of the at least one traveler, or the at least one traveler's company polices. The processing may occur upon determining that the at least one traveler is authorized to access the travel program management platform 112. The at least one processor 200 may be configured to perform a technical operation of processing the set of context-aware rules that may be encoded in the non-transitory rules engine. The context-aware rules may govern automated decision-making for real-time service provider selection within the travel program management platform 112. The non-transitory rules engine may encode dynamic and enterprise-specific logic, and may enable automated and adaptive determination of the list of the one or more service providers.

The prior travel history may correspond to a log or record of each of the one or more traveler's past interactions with the one or more service providers. The prior travel history may comprise information related to what flights, hotels, or loyalty programs used before, and travel frequency. Further, the at least one traveler's company polices may correspond to travel management rules and restrictions defined by the enterprise. The at least one traveler's company polices may include approved airlines, hotel chains, booking class restrictions, or travel budget limits. In some embodiments, by utilizing the combination of the traveler's registration information, prior travel history of the at least one traveler, or the at least one traveler's company polices, the at least one processor 200 may dynamically determine a personalized list of the one or more service providers for each of the authenticated traveler of the one or more travelers. In some embodiments, the at least one processor 200 may be configured to display the determined list of the one or more service providers to the at least one traveler via the user device 110.

In some embodiments, the at least one processor 200 may be configured to receive the selection of service providers from the displayed list of the one or more service providers. After the determined list of the one or more service providers is displayed on the user device 110, the at least one processor 200 may be configured to receive the selection of service providers.

In some embodiments, once the at least one processor 200 receives the selection of service providers, the at least one processor 200 may be configured to enable the at least one traveler to search for and book at least one ticket from the selected service providers. The unified travel booking interface 212 may be configured to allow the at least one traveler to perform travel-related operations. The travel-related operations may comprise at least one of entering travel details, viewing available travel options, and confirming a booking. The travel details may comprise at least one of source, destinations, dates, and preferences. The unified travel booking interface 212 may further provide the unified access to the one or more service providers comprising at least one of the airline provider, the hotel provider, the parking service, the dining provider, the rail services and the rental car service. Through the unified access to the one or more service providers, the at least one traveler may conveniently interact with the one or more service providers from a single travel program management platform 112.

In some embodiments, a user may define one or more email domains to restrict self-registration and sign-ups via shareable links. The user may define the one or more domains remotely (online). The user may correspond to a travel manager or an administrator. The user may ensure that only the one or more travelers with the email ID matching one or more email domains are permitted to register to the one or more service providers. Each domain to be added in the one or more email domains may require verification through a four-digit code sent to a valid email address associated with the respective domain. The user may enter the four-digit code into the user device 110 to confirm access and prevent unauthorized domain use. The domain may remain in a pending verification state until successfully verified. The verified domains may be applied globally to all shareable links and self-registrations. If one or more enterprises use the same domain, then the one or more travelers attempting to register with the domain may receive a verification email and be presented with a list of eligible enterprises to select from. It may be noted that the user may remove any verified domain at any time.

In one example embodiment, the user may establish the SAML SSO connection remotely. At first, the user may confirm the one or more domains associated with the enterprise. Further, the user may add the travel management program 110 to the IDP. Further, the user may configure the SAML SSO on the travel management program 112. Further, the user may add the SAML SSO details to The IDP. Lastly, the user may set up a system for cross-domain identity management (SCIM) Provisioning.

In some embodiments, the access to the unified travel booking interface 212 may be restricted based on a traveler email domain. The one or more travelers may be authorized through a self-registration mechanism when an email domain provided by the one or more travelers may match the at least one verified email domain configured by the user of the enterprise. The access to the unified travel booking interface 212 may be controlled based on the email domain of the email ID entered by the one or more travelers. In some embodiments, the one or more travelers attempting to register may be allowed access to the one or more service providers only if the domain provided by the one or more travelers matches at least one of the verified domains that may be configured by the user. The verification process may ensure that only the one or more travelers with authorized corporate email domains may gain entry.

In some embodiments, the user may enable a setting that may require an approval for the one or more travelers attempting to register through the self-registration mechanism. When the setting is activated, the one or more travelers may be placed in a pending state upon registration. The access to the unified travel booking interface 212 may be restricted based on an administrative approval. The one or more travelers may be placed in a pending state in response to a registration attempt, and access may be granted on an approval from the user of the enterprise. The user may approve or deny the access to the one or more travelers via the user device 110. In some embodiments, upon approval, the one or more travelers may be added to an active one or more travelers list and granted access to the unified travel booking interface. Further, upon denial, the one or more travelers may be removed from the pending state.

In one example embodiment, the one or more travelers may be registered with an identity providers and directory service. Further, the one or more travelers registered with identity providers and directory service may be able to utilize the SSO mechanism 214 or one or more Security Assertion Markup Language (SAML) options to log into or sign up for the travel management program 112. A verification will occur when the one or more travelers may enter his/her email address. If the email address is not recognized, the one or more travelers may receive an error stating that their account has not been configured to please register or sign in another way.

In some embodiments, the user may receive an email notification alerting the user of the one or more travelers in the pending state. The one or more travelers in the pending state may also receive a message on the user device 110 that may indicate that the approval is awaited. The user may view all such the one or more travelers in the pending state and may take an action to either approve or deny the access. Upon approval, the one or more travelers may be added to an active one or more travelers list and may be further notified via an email. If denied, the one or more travelers may be removed from the pending state and may be further informed via an email to contact the user.

In some embodiments, if the user may invite the one or more travelers directly via an email, the approval requirement may not apply, and the invited one or more travelers may be automatically approved upon successful registration. In some embodiments, if both the email domain restriction and the approval settings are enabled, the one or more travelers may first register using a verified domain associated with the enterprise, and then wait for the user approval to gain access. All approval or denial actions may be logged in an activity feed for transparency and access control monitoring. In some embodiments, the at least one processor 200 may be configured to receive a selection of service providers from the displayed list of the one or more service providers. After the determined list of the one or more service providers is displayed on the user device 110, the at least one processor 200 may be configured to receive the selection of service providers.

In some embodiments, once the at least one processor 200 receives the selection of service providers, the at least one processor 200 may be configured to enable the at least one traveler to search for and book at least one ticket from the selected service providers. The unified travel booking interface 212 may be configured to allow the at least one traveler to perform travel-related operations. The travel-related operations may comprise at least one of entering travel details, viewing available travel options, and confirming a booking. The travel details may comprise at least one of source, destinations, dates, and preferences. The booking interface may further provide the unified access to the one or more service providers comprising at least one of the airline provider, the hotel provider, the parking service, the dining provider, the rail services and the rental car service. Through the unified access to the one or more service providers, the at least one traveler may conveniently interact with the one or more service providers from a single travel program management platform 112.

In some embodiments, the at least one processor 200 may be configured to initiate the directory linkage between the ERP database 104 associated with the enterprise and the service provider database 106 associated with the selected service providers from the one or more service providers via the API module 114. Once the one or more travelers selects the service providers from the one or more service providers, the at least one processor 200 may be configured to initiate the directory linkage. The directory linkage may be established between the ERP database 104, and the service provider database 106. The ERP database 104 may store the one or more traveler's registration information of the at least one traveler and organizational information for the enterprise. Further, the service provider database 106 may be associated with the selected service providers from the one or more service providers.

In some embodiments, the at least one processor 200 may be configured to link, using the API module 114, the service provider database 106 with the ERP database 104. The service provider database 106 may be associated with the selected service providers by the at least one traveler. The linking process may be performed by executing data normalization, conflict resolution across heterogeneous profile fields, and asynchronous credential synchronization using a hashing-based token map. The linking process may allow the at least one traveler to access to the selected service providers via the travel program management platform 112. The directory linkage may be created using the API module 114. The API module 114 may act as a secure communication bridge that may allow the ERP database 104, and the service provider database 106 to exchange information. By initiating the directory linkage, the at least one processor 200 may enable the selected service providers from the one or more service providers to access one or more details of the at least one traveler from the one or more traveler's registration information.

In some embodiments, the at least one processor 200 may be configured to synchronize the one or more traveler's registration information of the one or more travelers from the ERP database 104 with the service provider database 106 associated with the selected service providers via a directory synchronization module 204. After establishing the directory linkage between the ERP database 104 and the service provider database 106, the at least one processor 200 may be configured to synchronize the one or more traveler's registration information of the one or more travelers between the ERP database 104 and the service provider database 106. The directory synchronization module 204 may ensure that the one or more traveler's registration information of the at least one traveler in the ERP database 104 may be automatically and accurately copied, and updated in the service provider database 106. By performing the synchronization process, the at least one processor 200 may ensure that each of the one or more service providers may have the recent one or more traveler's registration information.

In some embodiments, if the ERP database 104 shows that the one or more travelers is currently employed by the enterprise, the at least one processor 200 may automatically enroll the one or more travelers into the one or more service providers. Further, if the ERP database 104 indicates that the one or more travelers has left the company, the at least one processor 200 may automatically de-enroll the one or more travelers from the one or more service providers.

In one example, if one or more travelers joins an enterprise, changes departments, or leaves the enterprise, then the directory synchronization module 204 may detect the changes in the ERP database 104 in real-time. The directory synchronization module 204 may further update the detected changes in the service provider database 106 in real-time. In some embodiments, based at least on the employment status of the one or more travelers, the at least one processor 200 may be configured to automatically enroll or de-enroll the one or more travelers in or from the one or more service providers. Enrollment of the one or more travelers in the one or more service providers may involve sending one or more traveler's registration information of a new one or more travelers stored in the ERP database 104 to the service provider database 106 corresponding to each of the one or more service providers. Enrollment may authorize the one or more travelers to access the one or more service providers. The new one or more travelers may correspond to a new employee on-boarded to the enterprise. Enrollment to the one or more service providers may occur when a new one or more travelers may join the enterprise.

In some embodiments, the at least one processor 200 may be configured to perform automatic enrollment or de-enrollment of the at least one traveler in the selected service providers from the one or more service providers based on the employment status of the at least one traveler within the ERP database 104. The employment status of the at least one traveler may correspond to whether the at least one traveler is working in the enterprise or not. The at least one processor 200 may be configured to add or remove the at least one traveler from the service provider database 106 based at least on addition and removal of the at least one traveler to or from the ERP database 104.

In some embodiments, if the ERP database 104 shows that the at least one traveler is currently employed by the enterprise, then the at least one processor 200 may automatically enroll the at least one traveler into the selected service providers. The at least one processor 200 may be configured to receive the traveler's registration information associated with the at least one traveler of the one or more travelers from at least one user for enrollment with the travel program management platform 112. The at least one processor 200 may be further configured to store the received the traveler's registration information associated with the at least one traveler of the one or more travelers within the ERP database 104. Further, if the ERP database 104 indicates that the at least one traveler has left the enterprise, the at least one processor 200 may automatically de-enroll the at least one traveler from the selected service providers. In some embodiments, the at least one processor 200 may be further configured to execute de-enrollment of the at least one traveler from the travel program management platform 112 upon determining that the at least one traveler is not authorized to access the travel program management platform 112.

In an example embodiment, the directory synchronization module 204 may allow the at least one processor 200 to map or create workspaces/teams that exists on the IDP so that the one or more travelers may be managed and placed into different groups on the IDP. In some embodiments, with the IDP, the at least one processor 200 may allow the user to map the one or more traveler's registration information from the ERP database 104 to the service provider database 106. This may help in mapping user email addresses and names but may also include department and groups that are mapped to workspaces/teams.

The at least one processor 200 may automatically create the corresponding workspaces/teams that map to the enterprise's department and groups coming from the IDP. The user may not be able to alter the membership of the created workspaces/teams or may not edit (rename/delete) the workspaces/teams that were created, instead they would have to manage that on the IDP. Further, the user may only sync the desired one or more travelers from the IDP to the travel management program 112. The desired one or more travelers may correspond to certain people/departments/groups. The user may have the ability to require that the one or more travelers may sign in via the SSO mechanism 214. The ERP database 104 may further store cost center and the number of the employees associated with the enterprise.

In some embodiments, the at least one processor 200 may be further configured to detect the changes in the employment status of the at least one traveler in the ERP database 104 indicating the at least one traveler has left the enterprise. If the one or more traveler's registration information of the at least one traveler is removed from the ERP database 104, then the at least one processor 200 may detect the removal of the one or more traveler's registration information of the at least one traveler. The removal of the one or more traveler's registration information of the at least one traveler may indicate that the at least one traveler may have left the enterprise.

In some embodiments, the at least one processor 200 may be further configured to transmit a deactivation instruction via the API module 114 to the service provider database 106 associated with each of the one or more service providers. Once the at least one processor 200 detects that the at least one traveler has left the enterprise, the at least one processor 200 may be configured to generate a deactivation instruction. The at least one processor 200 may be configured to transmit the generated deactivation instruction through the API module 114. The instruction may be sent to the service provider database 106 associated with the selected service providers in which the at least one traveler was previously enrolled in. The deactivation instruction may ensure that the at least one traveler that may left the enterprise and may have no longer access to the one or more service providers.

In some embodiments, the at least one processor 200 may be further configured to revoke access for the at least one traveler to the unified travel booking interface 212 based on the deactivation instruction. The at least one processor 200 may be configured to use the deactivation instruction to revoke the access for the at least one traveler to the unified travel booking interface. The at least one traveler may no longer be able to log in, view, or interact with the system 100. The revocation may maintain data security, and may further ensure compliance with enterprise access policies, and may prevent unauthorized travel activity by the at least one traveler who are no longer affiliated with the enterprise.

In some embodiments, the unified travel booking interface may be dynamically personalized with content, branding elements, and policy rules specific to the enterprise of the one or more travelers. In one example, the personalization may include adapting visual appearance and structure of the unified travel booking interface with the content and the branding elements that may reflect the enterprise. The branding elements may include at least one of logos, colors, and messaging. In another example, the booking interface may apply the policy rules defined by the enterprise. The policy rules may comprise at least one of travel restrictions, budget limits, preferred vendors, and approval workflows. The policy rules may be automatically enforced through the unified travel booking interface to ensure that the travel activity of the one or more travelers may comply with the travel policies of the enterprise.

In some embodiments, the at least one processor 200 may be further configured to integrate with an ERP module to manage custom data fields associated with the one or more traveler's registration information of the one or more travelers. The ERP module may be used by the enterprise to manage one or more business operations. The one or more business operations may comprise at least one of finance, human resources, and procurement. The integration with the ERP module may allow the at least one processor 200 to retrieve and manage the custom data fields that may be associated with the one or more traveler's registration information of the one or more travelers. The custom data fields may include at least one of budget codes, cost centers, approval hierarchies, project identifiers, or travel entitlements. The custom data fields may be specific to the enterprise.

In some embodiments, the at least one processor 200 may be configured to generate data visualizations of enterprise travel data based at least on one or more one or more travelers-defined or enterprise-specific parameters, via the user device 110. The visualizations may be displayed on the user device 110. The data visualizations may comprise one or more data that may be relevant to the enterprise. The data visualizations comprise at least one of a total spend, user activity, and discount utilization.

In some embodiments, the at least one processor 200 may be configured to provide real-time analytics and reporting via the user device 110 based on the generated data visualizations. The at least one processor 200 may be configured to continuously analyze up-to-date enterprise specific parameters and instantly deliver insights to the one or more travelers. The insights may be displayed through dynamic dashboards or reports on the user device 110. The insights may allow the at least one traveler to monitor key metrics, identify trends, and make informed decisions without delay.

The at least one processor 200 may include suitable logic, circuitry, and/or interfaces that are operable to execute the one or more computer readable instructions stored in the memory 202 to perform predetermined operations. In some embodiments, the at least one processor 200 may be configured to store the login credentials, the one or more traveler's registration information, and the data visualizations in the memory 202 communicatively coupled to the at least one processor 200. In one embodiment, the at least one processor 200 may be configured to decode and execute any instructions received from one or more other electronic devices or server(s). The at least one processor 200 may be configured to execute one or more computer-readable program instructions, such as program instructions to carry out any of the functions described in this description. Further, the processor may be implemented using the at least one processor 200 technologies known in the art. Examples of the at least one processor 200 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to store login credentials received via the user device 110. The memory 202 may be configured to include the instructions to authenticate the one or more travelers via the SSO mechanism 214 integrated with the IDP. The memory 202 may be configured to store the one or more traveler's registration information of the one or more travelers. The one or more traveler's registration information may comprise at least one of the one or more travelers name, the email ID, the employee ID, the department, the discount code, and the project code.

In some embodiments, the memory 202 may be configured to include the instructions for synchronizing the ERP database 104 associated with the enterprise and the service provider database 106 associated with the selected travel program in real-time. The memory 202 may include instructions for authorizing access to the unified travel booking interface 212 and enabling the one or more travelers to perform the booking operations across the one or more service providers comprising at least one of the airline provider, the hotel provider, the parking service, the dining provider, the rail service, and the rental car service. Further, the memory 202 may be configured to store the enterprise-specific parameters and instructions for dynamically personalizing the booking interface with the content, the branding, and the policy rules specific to the enterprise of the one or more travelers.

It is apparent to a person with ordinary skill in the art that the one or more computer readable instructions stored in the memory 202 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the system 100 may further comprise an input/output circuitry 208. The input/output circuitry 208 may enable a user to communicate or interface with the system 100, via the user device 110. The user device 110 may include N number of user devices corresponding to different users affiliated with the enterprise. In some embodiments, the input/output circuitry 208 may act as a medium to transmit input from the interface to and from the system 100. In some embodiments, the input/output circuitry 208 may refer to the hardware and software components that facilitate bidirectional data exchange, including user authentication data, search queries, booking inputs, and one or more traveler's registration information. In one example, the system 100 may include a graphical one or more travelers interface (GUI) (not shown) as part of the input circuitry, which may allow the one or more travelers to enter authentication credentials, view personalized booking options, and initiate bookings across the one or more service providers. The input/output circuitry 208 may include various input components such as keyboards, touchscreens, and graphical widgets, enabling the one or more travelers to provide data such as travel preferences, project codes, or discount codes. In another example, the input/output circuitry 208 may include various output circuitry such as a display to convey information including booking confirmations, travel policies, or enterprise-specific visualizations.

In some embodiments, the server 108 may further comprise a communication circuitry 210. The communication circuitry 210 may allow the system 100 to exchange data or information with external systems, the ERP database 104, the IDP, and the service provider database 106. Further, the communication circuitry 210 may include network interfaces, protocols, and software modules responsible for sending and receiving data or information. In some embodiments, the communication circuitry 210 may include Ethernet ports, Wi-Fi adapters, or communication protocols like HTTP or MQTT for connecting with other systems. The communication circuitry 210 may further include components such as communication modules (e.g., Wi-Fi, Ethernet, cellular), transceivers, antennas, and protocols (e.g., TCP/IP, MQTT, SNMP) for exchanging data with other systems or network devices. The components may facilitate interaction with the API module 114, allowing the at least one processor 200 to transmit the one or more traveler's registration information, search requests, booking data, and enterprise-specific configurations across the one or more service providers. Further, the communication circuitry 210 may ensure that real-time synchronization of the one or more traveler's registration information of the one or more travelers between the ERP database 104 the service provider database 106 is secure, reliable, and efficient. The communication circuitry 210 may also enable the at least one processor 200 to maintain continuous connectivity with the ERP module and the directory synchronization module 204 to dynamically manage one or more travelers access, entitlements, and booking policies based on enterprise-specific parameters.

It will be apparent to one skilled in the art the above-mentioned components of the system 100 have been provided only for illustration purposes, without departing from the scope of the disclosure.

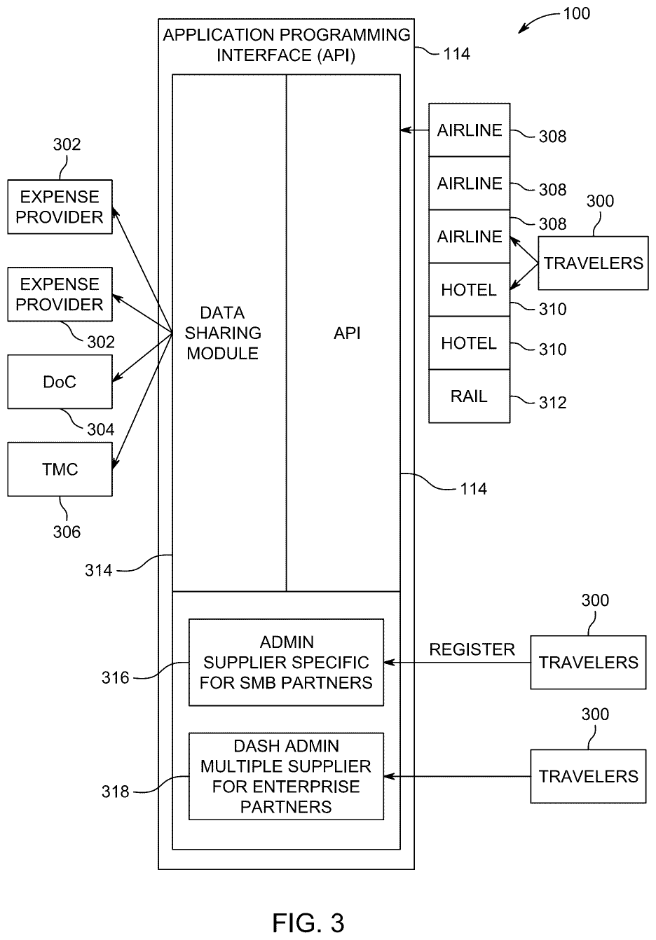

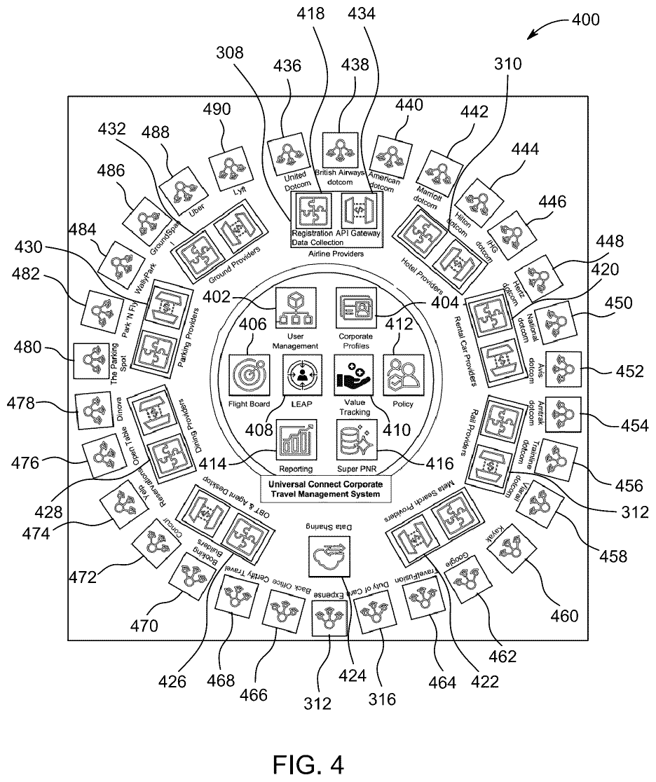

FIG. 3 illustrates a system architecture for the centralized travel program management system 100 showing data communication in accordance with an example embodiment of the present disclosure. FIG. 4 illustrates a schematic diagram of a centralized travel program management hub 400 showing integration of the one or more service providers in accordance with an example embodiment of the present disclosure.

In some embodiments, the at least one traveler 300 may engage with the one or more service providers. The one or more service providers may comprise at least one of the airline provider 308, the hotel provider 310, and the rail provider 312. The at least one traveler 300 may initiate activities such as registering, booking, or updating travel preferences directly with the one or more service providers. The interaction between the at least one traveler 300 and the one or more service providers may result in generation of travel-related data associated with the at least one traveler 300. The ERP database 104 and the service provider database 106 may store the travel-related data associated with the at least one traveler 300.

In some embodiments, the generated travel-related data may be transmitted to the API module 114. The API module 114 may correspond to a secure and standardized gateway that may receive the travel-related data from the one or more service providers. The API module 114 may facilitate real-time travel-related data ingestion to the system 100. Once the travel-related data enters the API module 114, the travel-related data may be processed and managed by a data sharing module 314. The data sharing module 314 may govern internal routing, normalization, access control, and outbound sharing of the data. The data sharing module 314 may enable secure and permission-based dissemination of relevant travel information to the one or more service providers.

In some embodiments, the data sharing module 314 may further transmit the processed data to one or more expense providers 302 for travel expense reconciliation. The data Sharing module 314 may further transmit the processed data to a department of commerce (DoC) 304 for compliance or policy validation. The data sharing module 314 may further transmit the processed data to a travel management company (TMC) 306 for one or more services. The one or more services may comprise itinerary monitoring, policy enforcement, and one or more travelers support.

In some embodiments, the at least one traveler 300 may register via a Admin module 316 or via a DASH admin module 318. The admin module 316 may correspond to a admin supplier specific for small and medium business (SMB) partner. The admin module 316 may be configured for SMB partners that may manage a single supplier. The DASH admin module 318 may support enterprise partners that may manage the plurality of travel suppliers. The admin module 316 may be configured to ensure that the travel-related data associated with the at least one traveler 300 may be properly mapped to a correct partner structure.

In some embodiments, the centralized travel program management hub 400 comprise the one or more service providers. The centralized travel program management hub 400 may connect and synchronize the travel-related data between the ERP database 104 and the service provider database 106. The centralized travel program management hub 400 may comprise a plurality of layers. The core layer of the centralized travel program management hub 400 may comprise a first set of modules. The first set of modules may comprise a user management module 402, a corporate profile module 404, a flight board module 406, a LEAP module 408, a value tracking module 410, a policy module 412, a reporting module 414, and a super PNR module 416.

In some embodiments, the first set of modules may be responsible for managing the one or more traveler's registration information of the one or more travelers, corporate travel rules, itineraries, and reporting functions. The user management module 402 may be configured to manage user roles, permissions, and profiles. The corporate profile module 404 may be configured to store and configure company-specific travel rules and profiles. The flight board module 406 may be configured to display flight-related information to the one or more travelers and the user. Further, the LEAP module 408 may correspond to a predictive analytics engine for learning enterprise activity patterns. Further, the value tracking module 410 may track discounts, credits, and negotiated rates. Further, the policy module 412 may be configured to manage and enforce the travel policies. The reporting module 414 may be configured to generate visual and tabular reports on travel spend, activity, and compliance. Further, the super PNR module 416 may be configured to consolidate multi-supplier bookings into a single travel record.

In some embodiments, surrounding the core layer of the centralized travel program management hub 400 is a middle integration layer. The middle integration layer may comprise a second set of modules. The second set of modules may correspond to the plurality of travel providers of the one or more service providers. The plurality of travel providers may comprise at least one of the airline provider 308, the hotel provider 310, a rental car provider 420, the rail provider 312, a meta search provider 422, a data sharing 424, an OBT and Agent desktop 426, a dining provider 428, a parking provider 430, and a ground provider 432. Each of the second set of modules may comprise a registration data collection module 418 and an API module gateway 434. The second set of modules may interact via the API module 114 for registration, profile updates, and real-time data exchange. By utilizing the API module gateway 434 and the directory synchronization module 204, the API module 114 may enable each of the second set of modules to automatically receive and update the one or more traveler's registration information of the one or more travelers.

In some embodiments, surrounding the middle integration layer of the centralized travel program management hub 400 is an outermost layer. The outermost layer may comprise the one or more service providers corresponding to each of the second set of modules. The second set of modules may correspond to the one or more service providers. A plurality of providers corresponding to the airline provider 308 may comprise at least one of United dotcom 436, British Airways dotcom 438, and an American dotcom 440. A plurality of providers corresponding to the hotel provider 308 may comprise at least one of Marriott dotcom 442, Hilton dotcom 444, and IHG dotcom 446. Further, a plurality of providers corresponding to the rental car provider 420 may comprise at least one of Hertz dotcom 448, National dotcom 450, and Avis dotcom 452. Further, a plurality of providers corresponding to the rail provider 312 may comprise at least one of Amtrak dotcom 454, trainline dotcom 456, and viarail dotcom 458. Further, a plurality of providers corresponding to the meta search provider 422 may comprise at least one of Kayak 460, Google 462, and TravelFusion 464. Further, a plurality of providers corresponding to the data sharing 424 may comprise at least one of duty of care (DoC) 304, expense provider module 302, and back office 466. Further, a plurality of providers corresponding to the OBT and Agent Desktop 426 may comprise at least one of certify travel 468, booking builders 470, and concur 472. Further, a plurality of providers corresponding to the dining provider 428 may comprise at least one of Yelp reservations 474, Open Table 476, and Dinova 478. Further, a plurality of providers corresponding to the parking provider 430 may comprise at least one of the parking spot 480, park n fly 482, and wallypark 484. Further, a plurality of providers corresponding to the ground provider 432 may comprise at least one of GroundSpan 486, Uber 488, and Lyft 490.

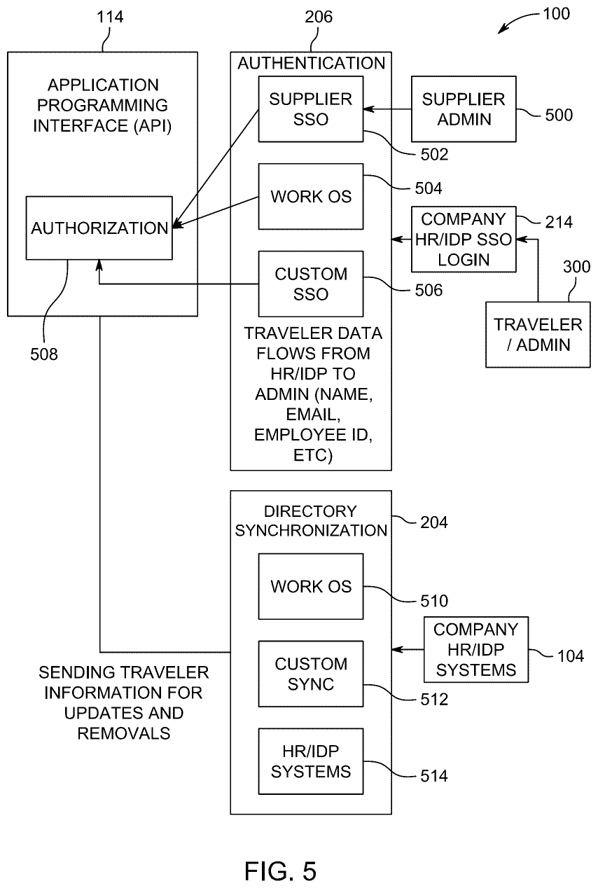

FIG. 5 illustrates a block diagram of the centralized travel program management system in accordance with an example embodiment of the present disclosure.

In some embodiments, the system 100 may include one or more segments that may interact to enable seamless enterprise user management, authentication, and data synchronization for the one or more service providers. The one or more segments may comprise at least one of the API 114, the authentication module 206 and the directory synchronization module 204.

In some embodiments, the at least one traveler 300 may log in using the SSO mechanism 214. The SSO mechanism 214 may connect to the Authentication module 206. The Authentication module 206 may include three types of SSO units. The SSO mechanism 214 may include a supplier SSO 502, a work OS 504, and a custom SSO 506. The supplier SSO 502 may be used to access external supplier systems. The work OS 504 may be a standard enterprise or a collaboration platform used within the enterprise. The custom SSO 506 may be a tailored authentication service that may fit enterprise-specific needs.

In some embodiments, the ERP database 104 may store traveler details. The details may include name, email, and employee ID. The ERP database 104 may send the traveler data to the directory synchronization module 204. The directory synchronization module 204 may include three components. The three components may comprise the work OS 510, custom sync 512, and HR/IDP Systems 514. The work OS 510 may handle structured directory updates. The custom sync 512 may manage integration with custom fields. The HR/IDP Systems 514 may act as a source of truth for employee records.

In some embodiments, the traveler data may flow from the ERP database 104 to the authorization module 508 and the API module 114. The flow may ensure that only valid travelers are given the authorization using the authorization module 508 to use the one or more service providers. The API module 114 may allow the authorized travelers to access the one or more service providers. The one or more service providers may be managed by a supplier Admin 500. The API module 114 may also support updates and removals of traveler data for consistency across the system 100.

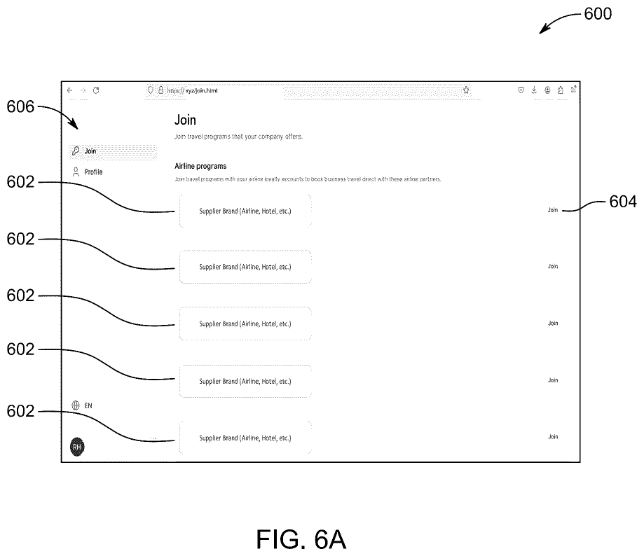

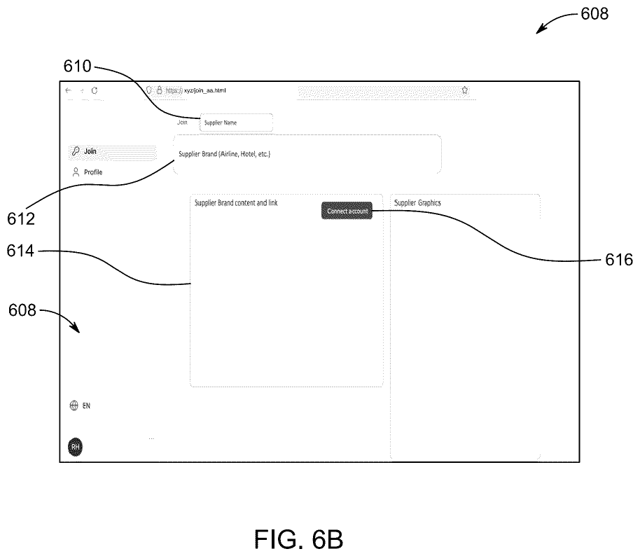

FIGS. 6A-6B illustrate a user interface of the travel program management platform 112 in accordance with an example embodiment of the present disclosure.

In some embodiments, FIG. 6A shows a user interface 600 for a Join page of the travel program management platform 112. At the join page the one or more travelers may browse and opt into the one or more service providers 602. The one or more service providers 602 may be associated with the airline provider 308, the hotel provider 310, the rental car provider 420, the rail provider 312, the meta search provider 422, the dining provider 428, the parking provider 430, and the ground provider 432. The one or more service providers 602 may be presented as a list. Each entry of the one or more service providers 602 may be labeled with a generic placeholder. The generic placeholder may correspond to Supplier Brand (Airline, Hotel, etc.). In some embodiments, next to each of the one or more service providers 602 may be a Join button 604. The join button 604 may enable the at least one traveler 300 to initiate account linkage or enrollment with the selected travel supplier from the one or more service providers 602. The at least one traveler 300 may be guided through the booking process via a consistent and one or more travelers-friendly interface that may ensure seamless enrollment. Further, a navigation panel 606 may be positioned on a left side of the one or more travelers interface 600. The navigation panel 606 may include one or more options. The one or more options may comprise at least one of Join and Profile.

In some embodiments, FIG. 6B shows a subsequent one or more travelers interface 608 that may appear when the at least one traveler 300 selects a particular travel program from the one or more service providers 602 shown in FIG. 6A. The one or more travelers interface 608 may correspond to an individual travel program connection page, where the one or more travelers may proceed to connect an account of the at least one traveler 300 with the selected supplier of the one or more service providers 600. At the top of the one or more travelers interface 608, there may be a supplier name field 610 and a more detailed supplier description 612, again represented with the placeholder Supplier Brand (Airline, Hotel, etc.). Further, a supplier brand content and link field 614 may be provided on the one or more travelers interface 608. Within the supplier brand content and link field 614, a “Connect account” button 616 may be provided, which the one or more travelers may select to authenticate or authorize the linking of the corporate travel profile with the selected supplier's.

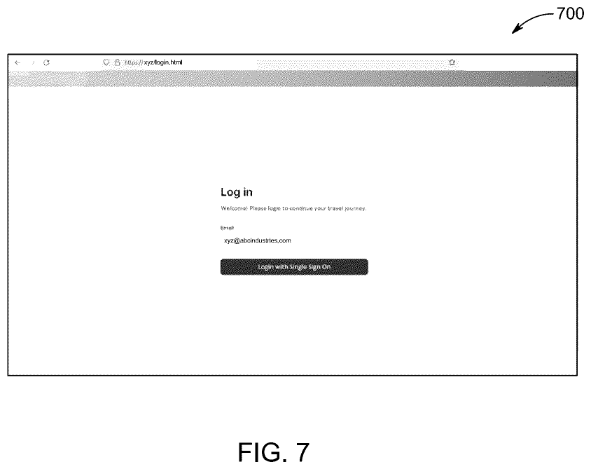

FIG. 7 illustrates a personalized user interface 700 of the of the travel program management platform 112 in accordance with an example embodiment of the present disclosure.

In some embodiments, the user interface 700 may be customized for a specific enterprise whose logo and name may be prominently displayed in a header area. The user interface 700 may represent a form of partner branding. The center of the user interface 700 may display a simplified login form, where the one or more travelers may be prompted to enter the email address. The login process may be enabled through the SSO mechanism 214. The login process may be indicated by a button labeled as “Login with Single Sign On.” The login window may authenticate the one or more travelers by using the valid login credentials of the one or more travelers. The login window may align with the system's authentication framework that may support multiple SSO mechanisms 214. The SSO mechanisms 214 may include at least one of work OS or custom SSO protocols.

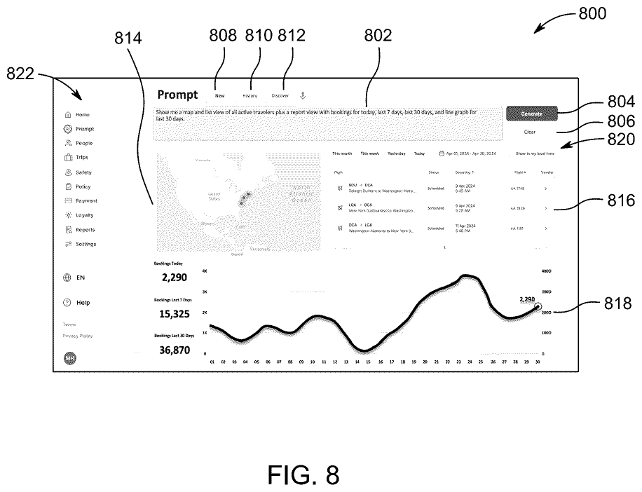

FIG. 8 illustrates a traveler analytics dashboard 800 of the of the travel program management platform 112 in accordance with an example embodiment of the present disclosure.

In some embodiments, the traveler analytics dashboard 800 may correspond to a dynamic, real-time data analytics visualization tool embedded within the of the travel program management platform 112. The traveler analytics dashboard 800 may allow the one or more travelers or the user to access and visualize travel-related data on demand using freeform text input. The traveler analytics dashboard 800 may respond to one or more travelers-specified queries, generating highly customized reports and visual summaries instantly. The traveler analytics dashboard 800 may include a text prompt bar 802 at the top where the one or more travelers or the user may type at least one instruction. In one example, the at least one instruction may comprise “Show a map and list view of all active travelers plus a report view with bookings for today, last 7 days, last 30 days, and line graph for last 30 days”. The at least one instruction may be submitted using a generate button 804. The generate button 804 may be positioned at a right side of the text prompt bar 802. Further, a clear button 806 may be positioned below the generate button 804. The clear button 806 may be configured to allow the at least one traveler or the user to remove the at least one instruction.

Further, at least three selectable history tabs may be positioned above the text prompt bar 802. The at least three selectable history tabs may comprise a new tab 808, a history tab 810, and a discover tab 812. The new tab 808 may be configured to enter a new instruction in the text prompt bar 802. Further, the history tab 810 may be configured to review past instructions. Further, the discover tab 812 may be configured to show recommended instructions. Based on the at least one instruction, the system 100 may process and returns a set of dynamic visualizations, including a geographic map 814, a data table 816 of recent trips, and a line graph 818 illustrating booking trends over time. Further, the geographic map 814 positioned to the left of the data table 816 may highlight current location of the at least one traveler or the user across the globe. Further, the data table 816 may display detailed trip information including flight route information, departure and arrival locations, flight status, departure time and data, flight number, and traveler profile. Further, the line graph 818 may visually track the volume of bookings across multiple days, with key indicators like “Bookings Today,” “Bookings This Week,” and “Bookings This Year” displayed on the left of the line graph 818.

In some embodiments, a plurality of filter tabs 820 may be positioned above the data table 816. The plurality of filter tabs 820 may be configured to allow the at least one traveler or the user to filter travel data based on specific time ranges. In one example, the plurality of filter tabs 820 may comprise at least a “this month” tab, a “this week” tab, a “yesterday” tab, and a “today” tab. The plurality of filter tabs 820 may further comprise a calendar range selector configured to allow date-specific filtering, and a checkbox for local time display toggle. On a left panel of the traveler analytics dashboard 800, a vertical navigation menu bar 822 may be present. The vertical navigation menu bar 822 may comprise a plurality of sections of the travel program management platform 112. The plurality of sections may comprise at least one of home, prompt, people, trips, safety, policy, payment, loyalty, reports, settings, language selection, help button, terms option, privacy policy, and user avatar.

In one example, a universal connect (UC) may correspond to the centralized travel program management system 100 that may be configured to help the enterprise manage all travel activities of the one or more travelers in one place. The UC may be configured to connect the one or more travelers with the one or more service providers. The UC may use the one or more traveler's registration information stored in the ERP database 104 to check if the at least one traveler of the one or more travelers is allowed to access the one or more service providers. The UC may be further configured to keep the one or more traveler's registration information updated and secure. Through the UC, the one or more travelers may book at least one ticket associated with the travel and may manage the travel while the enterprise may maintain control and visibility over program eligibility rules, travel policies, and expense.

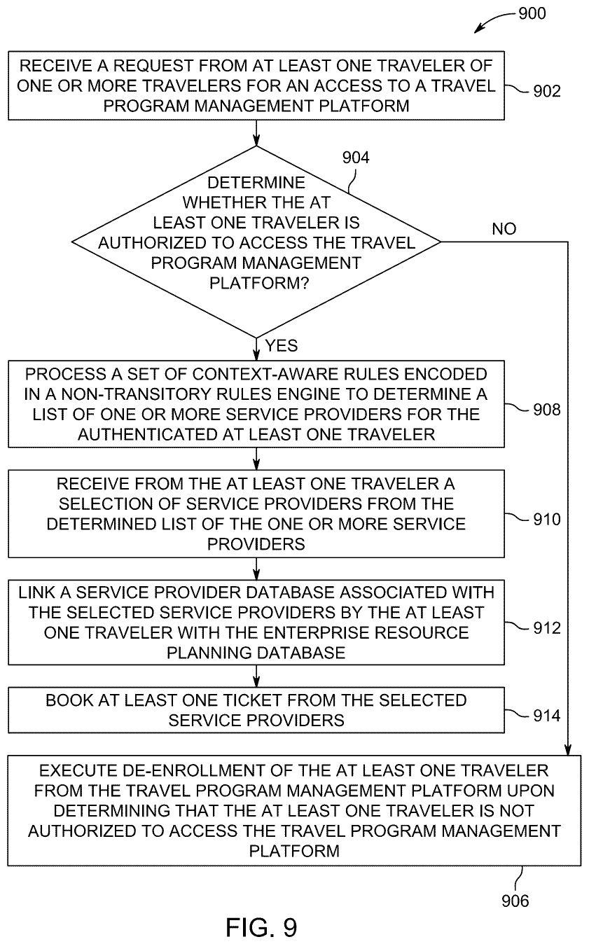

FIG. 9 illustrates a flowchart 900 showing a method for managing the one or more service providers in accordance with an example embodiment of the present disclosure.

At operation 902, the at least one processor 200 receives the request from the at least one traveler of the one or more travelers for the access to the travel program management platform 112. The at least one processor 200 receives the request from the at least one traveler via the user device 110. The request corresponds to the login request to access the travel program management platform 112. The at least one user enters the login credential associated with the request entered by the at least one traveler. The login credential comprises at least one of the user name, the mobile number, or the user ID, and the password associated with the user name, the mobile number, or the user ID.

In one example, at least one traveler uses a laptop to open the travel program management platform 112 and enter a login credential corresponding to a request to access the travel program management platform 112 using the laptop. The at least one traveler enters the employee ID and a corresponding password. The employee ID may be “xyz@html.com” and the corresponding password may be “password”.

At operation 904, the at least one processor 200 determines whether the at least one traveler is authorized to access the travel program management platform 112. The at least one processor 200 determines whether the at least one traveler is authorized to access the travel program management platform 112 based on the data stored in the ERP database 104, changes in the employment status of the at least one traveler within the ERP database 104, and real-time verification of the program eligibility rules stored in the service provider database 106. The at least one processor 200 confirms from the one or more traveler's registration information whether the at least one traveler trying to access the travel program management platform 112 is officially registered and recognized by the enterprise. Further, the at least one processor 200 looks at changes in the employment status of the at least one traveler within the ERP database 104. Further, the at least one processor 200 performs real-time verification of the program eligibility rules that are stored in the service provider database 106. The program eligibility rules are set by the enterprise or the one or more service providers. The program eligibility rules define one or more conditions under which the at least one traveler may access certain benefits, discounts, or the loyalty programs.

In one example, the at least one processor 200 checks whether the at least one traveler is an active employee of the enterprise by verifying the login credential, one or more traveler's registration information and an employment status stored in the ERP database 104. The employment status may be employed.

At operation 906, the at least one processor 200 executes de-enrollment of the at least one traveler from the travel program management platform 112 upon determining that the at least one traveler is not authorized to access the travel program management platform 112. The at least one processor 200 transmits the deactivation instruction via the API module 114 to the service provider database 106 associated with each of the one or more service providers. Once the at least one processor 200 detects that the at least one traveler has left the enterprise, the at least one processor 200 generates the deactivation instruction. The at least one processor 200 transmits the generated deactivation instruction through the API module 114. The deactivation instruction is sent to the service provider database 106 associated with the selected service providers in which the at least one traveler was previously enrolled in. The deactivation instruction ensures that the at least one traveler that lefts the enterprise have no longer access to the one or more service providers.

In one example, the at least one processor 200 detects that the at least one traveler has left the enterprise and automatically send a request to one or more service providers to remove access to the one or more service providers where the at least one traveler was previously enrolled. The one or more service providers may be Air India or Hilton Hotels.

At operation 908, the at least one processor 200 processes the set of context-aware rules encoded in the non-transitory rules engine to determine the list of the one or more service providers for the authenticated at least one traveler based at least on a combination of the traveler's registration information, prior travel history of the at least one traveler, or the at least one traveler's company polices, upon determining that the at least one traveler is authorized to access the travel program management platform 112. The prior travel history corresponds to a log of each of the one or more traveler's past interactions with the one or more service providers. The prior travel history comprises information related to what flights, hotels, or loyalty programs used before, and travel frequency.

In one example, the at least one processor 200 analyzes the traveler's past trips and check the company's travel policy to determine a list of the one or more service providers like airlines and hotels, the at least one traveler can use. The traveler's past trips may suggest that the at least one traveler prefers British Airways. Further, the company's travel policy may suggest that only the managers of the enterprise are allowed to see the list of the one or more service providers.

At operation 910, the at least one processor 200 receives the selection of service providers from the displayed list of the one or more service providers. After the determined list of the one or more service providers is displayed on the user device 110, the at least one processor 200 receives the selection of service providers.

In one example, the at least one traveler sees a list of the one or more service providers and selects one or more service providers, such as Air India or Taj Hotels, using the laptop.

At operation 912, the at least one processor 200 links, using the API module 114, the service provider database 106 associated with the selected service providers by the at least one traveler with the ERP database 104 by executing data normalization, conflict resolution across heterogeneous profile fields, and asynchronous credential synchronization using a hashing-based token map, for allowing the at least one traveler an access to the selected service providers via the travel program management platform 112. The directory linkage is created using the API module 114. The API module 114 acts as a secure communication bridge that allows the ERP database 104, and the service provider database 106 to exchange information.

In one example, the at least one processor 200 connects the traveler's employee profile from the ERP database 104 to the selected airline's system so the traveler's details are automatically filled in during booking.

At operation 914, the at least one processor 200 enables the at least one traveler to search for and book at least one ticket from the selected service providers. The unified travel booking interface allows the at least one traveler to perform travel-related operations. The travel-related operations comprise at least one of entering travel details, viewing available travel options, and confirming a booking. The travel details comprise at least one of source, destinations, dates, and preferences.

In one example, the at least one traveler may enter a trip from London to Bangalore for the next Monday, check available flights and hotels, and complete the booking.

The present disclosure offers several notable advantages. The system 100 provides a seamless and secure one or more travelers experience by enabling access through a SSO mechanism integrated with the IDP unit of the enterprise. The system 100 retrieves one or more traveler's registration information of the one or more travelers and leverages the one or more traveler's registration information to personalize the booking interface with the enterprise-specific branding, content, and policy rules. The system 100 ensures real-time synchronization of the one or more traveler's registration information across the one or more service providers using the directory synchronization module and the API module 114. The present disclosure eliminates the need for repetitive data entry and supports consistent access across services. Additionally, the system 100 automatically enrolls or de-enrolls the one or more travelers in the one or more service providers based at least on the employment status. Integration with the ERP module allows for retrieval and management of the custom one or more travelers data fields, enabling further personalization and reporting. The present disclosure also generates the enterprise-specific visualizations. Overall, the present disclosure delivers a comprehensive, efficient, and intelligent solution for enterprise travel management.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A centralized travel program management system comprising:
a memory having one or more computer readable instructions;
at least one processor communicatively coupled with the memory, wherein the at least one processor executing the one or more computer readable instructions stored in the memory is configured to:
receive a request from at least one traveler of one or more travelers for an access to a travel program management platform;
determine whether the at least one traveler is authorized to access the travel program management platform based on traveler's registration information stored in an enterprise resource planning database, changes in an employment status of the at least one traveler within the enterprise resource planning database, and real-time verification of program eligibility rules stored in a service provider database;
process a set of context-aware rules encoded in a non-transitory rules engine to determine a list of one or more service providers for the authenticated at least one traveler based at least on a combination of the traveler's registration information, prior travel history of the at least one traveler, or the at least one traveler's company polices, upon determining that the at least one traveler is authorized to access the travel program management platform;
receive, from the at least one traveler, a selection of service providers from the determined list of the one or more service providers;
link, using an application programming interface (API) module, the service provider database associated with the selected service providers by the at least one traveler with the enterprise resource planning database, for allowing the at least one traveler an access to the selected service providers via the travel program management platform; or
execute de-enrollment of the at least one traveler from the travel program management platform upon determining that the at least one traveler is not authorized to access the travel program management platform.

2. The centralized travel program management system of claim 1, wherein the at least one processor executing the one or more computer readable instructions stored in the memory is configured to receive the traveler's registration information associated with the at least one traveler of the one or more travelers from at least one user for enrollment with the travel program management platform, and wherein the at least one user corresponds to a travel manager or an administrator.

3. The centralized travel program management system of claim 2, wherein the at least one processor executing the one or more computer readable instructions stored in the memory is configured to store the received the traveler's registration information associated with the at least one traveler of the one or more travelers within the enterprise resource planning database.

4. The centralized travel program management system of claim 2, wherein the one or more traveler's registration information comprises at least a user name, an email ID, an employee ID, a department code, an expense code, a discount code, an employment status, and a project code.

5. The centralized travel program management system of claim 1, wherein the prior travel history corresponds to a log or record of each of the one or more traveler's past interactions with the one or more service providers, information related to what flights, hotels, or loyalty programs used before, and travel frequency.

6. The centralized travel program management system of claim 1, wherein the at least one processor is configured to link, using the API module, the service provider database associated with the selected service providers by the at least one traveler with the enterprise resource planning database, by executing data normalization, conflict resolution across heterogeneous profile fields, and asynchronous credential synchronization using a hashing-based token map.

7. The centralized travel program management system of claim 1, wherein the at least one processor executing the one or more computer readable instructions stored in the memory is further configured to generate data visualizations of the at least one traveler corresponding to the selected service providers, wherein the data visualizations comprise at least total spend, user activity, and discount utilization.

8. The centralized travel program management system of claim 7, wherein the at least one processor executing the one or more computer readable instructions stored in the memory is further configured to generate real-time analytics and reporting on the travel program management platform based on the data visualizations.

9. The centralized travel program management system of claim 1, wherein the at least one processor is further configured to authenticate, using a single sign-on mechanism, enrollment of the at least one traveler with the travel program management platform by validating the traveler's registration information in the enterprise resource planning database, wherein the single sign-on mechanism performs multi-factor cryptographic token validation using the enterprise resource planning database and dynamic session allocation for a secure access to a unified travel booking interface of the travel program management platform.

10. The centralized travel program management system of claim 9, wherein the unified travel booking interface is configured to provide a unified access to each of the one or more service providers, wherein the one or more service providers comprises at least one of an airline provider, a hotel provider, a parking service, a dining provider, a rail services and a rental car service.

11. A method comprising:
receiving, via at least one processor communicatively coupled with a memory having one or more computer readable instructions, a request from at least one traveler of one or more travelers for an access to a travel program management platform;
determining, via the at least one processor, whether the at least one traveler is authorized to access the travel program management platform based on traveler's registration information stored in an enterprise resource planning database, changes in an employment status of the at least one traveler within the enterprise resource planning database, and real-time verification of program eligibility rules stored in a service provider database;
processing, via the at least one processor, a set of context-aware rules encoded in a non-transitory rules engine to determine a list of one or more service providers for the authenticated at least one traveler based at least on a combination of the traveler's registration information, prior travel history of the at least one traveler, or the at least one traveler's company polices, upon determining that the at least one traveler is authorized to access the travel program management platform;
receiving, via the at least one processor, from the at least one traveler, a selection of service providers from the determined list of the one or more service providers;
linking, via the at least one processor, using an application programming interface (API) module, the service provider database associated with the selected service providers by the at least one traveler with the enterprise resource planning database, for allowing the at least one traveler an access to the selected service providers via the travel program management platform; or
executing, via the at least one processor, de-enrollment of the at least one traveler from the travel program management platform upon determining that the at least one traveler is not authorized to access the travel program management platform.

12. The method of claim 11 further comprising receiving, via the at least one processor executing the one or more computer readable instructions stored in the memory, the traveler's registration information associated with the at least one traveler of the one or more travelers from at least one user for enrollment with the travel program management platform, and wherein the at least one user corresponds to a travel manager or an administrator.

13. The method of claim 12 further comprising storing, via the at least one processor executing the one or more computer readable instructions stored in the memory, the received the traveler's registration information associated with the at least one traveler of the one or more travelers within the enterprise resource planning database.

14. The method of claim 12, wherein the one or more traveler's registration information comprises at least a user name, an email ID, an employee ID, a department code, an expense code, a discount code, an employment status, and a project code.

15. The method of claim 11, wherein the prior travel history corresponds to a log or record of each of the one or more traveler's past interactions with the one or more service providers, information related to what flights, hotels, or loyalty programs used before, and travel frequency.

16. The method of claim 11 further comprising linking, via the at least one processor, using the API module, the service provider database associated with the selected service providers by the at least one traveler with the enterprise resource planning database, by executing data normalization, conflict resolution across heterogeneous profile fields, and asynchronous credential synchronization using a hashing-based token map.

17. The method of claim 11 further comprising generating, via the at least one processor, data visualizations of the at least one traveler corresponding to the selected service providers, wherein the data visualizations comprise at least total spend, user activity, and discount utilization.

18. The method of claim 17 further comprising generating, via the at least one processor, real-time analytics and reporting on the travel program management platform based on the data visualizations.

19. The method of claim 11 further comprising authenticating, via the at least one processor, using a single sign-on mechanism, enrollment of the at least one traveler with the travel program management platform by validating the traveler's registration information in the enterprise resource planning database, wherein the single sign-on mechanism performs multi-factor cryptographic token validation using the enterprise resource planning database and dynamic session allocation for a secure access to a unified travel booking interface of the travel program management platform.

20. The method of claim 19, wherein the unified travel booking interface provides a unified access to each of the one or more service providers, wherein the one or more service providers comprises at least one of an airline provider, a hotel provider, a parking service, a dining provider, a rail services and a rental car service.
